(19) United States
(12) Patent Application Publication
(10) Pub. No.: US 2026/0230170 A1
(43) Pub. Date: Aug. 6, 2026

(54) METHODS AND SYSTEMS FOR MANAGING SATELLITE COMMUNICATION WITH NETWORK FUNCTIONS (NFS) ONBOARD THE SATELLITE

(71) Applicant: Samsung Electronics Co., Ltd., Suwon-si (KR)

(72) Inventors: Sidhant JAIN, Bangalore (IN); Lalith Kumar, Bangalore (IN); Aman Agarwal, Bangalore (IN); Dinesh Rooparam Choudhary, Bangalore (IN); Varini Gupta, Bangalore (IN)

(21) Appl. No.: 19/631,398

(22) Filed: Mar. 27, 2026

(30) Foreign Application Priority Data
Sep. 29, 2023 (IN) 202341065791
Sep. 12, 2024 (IN) 202341065791

(51) Int. Cl. H04B 7/185

(52) U.S. Cl. CPC H04B 7/18513

(57) ABSTRACT

Methods and/or systems for managing satellite communication using a store and forward (S&F) service with at least one network node onboard satellite. An example method may include: determining, by a User Equipment (UE), that a network supports the store and forward service; and initiating, by UE, at least one Non-Access Stratum (NAS) procedure with network, wherein UE re-attempts to provide a NAS signaling based on received at least one store and forward information. Determining, by a core network node, that at least one NAS procedure initiated by UE cannot be completed due to store and forward (S&F) operation, wherein core network node onboard the network; and providing, by core network node, at least one S&F information to UE, wherein S&F information comprises an indication of UE in S&F operation, list of Satellite Identifications (IDs), and S&F wait timer.

### CROSS-REFERENCE TO RELATED APPLICATIONS

This application is a continuation application of International Application No. PCT/KR2024/014778, filed on Sep. 27, 2024, in the Korean Intellectual Property Receiving Office, and claiming priority to IN Provisional Application No. 202341065791 filed Sep. 29, 2023, and to IN Complete Application No. 202341065791 filed Sep. 12, 2024, the disclosures of which are all hereby incorporated by reference herein in their entireties.

### TECHNICAL FIELD

Certain example embodiments may relate to satellite communications, and for example to a satellite communication network comprising at least one Network Function (NF) onboard the satellite using a store and forward operation.

### BACKGROUND

Currently, when using Fifth Generation (5G) network with the satellite access, the 5G network may provide services between a New Radio (NR) terrestrial access network and a NR satellite access network owned by the same operator or different operators having a mutual agreement. The Non-Terrestrial Network (NTN) and Terrestrial Network (TN) could either operate in two different frequency bands (e.g., Frequency Range 1(FR1 ) vs. Frequency Range 2(FR2 )) or in the same frequency band (e.g., FR1 or FR2).

In the 5G network, the store and forward satellite operations may provide communication services to a User Equipment (UE). The communication services may comprise the satellite coverage with intermittent or temporary satellite connectivity (e.g.,, when the satellite is not connected through a feeder link or through Inter-Satellite Link (ISL) to the ground network or when both the service link and the feeder link are not available) for delay-tolerant communication service.

In existing terrestrial networks, the core network entities or the Network Functions (NFs) may be connected to each other. Because of the interconnected nature, the procedures between the UE and the network, as well as between different network functions or entities, can be conducted seamlessly without any significant delay.

In store and forward operations, the link between the UE and the satellite (service link) and the link between the satellite and the ground station (feeder link) are not connected at the same time. Thus, any procedure, such as attach/registration, which requires interaction between the UE and the ground station, needs to be modified to account for the non-availability of the feeder link and service link at the same point in time.

Therefore, the communication procedures between the UE and the network are defined for terrestrial networks, wherein the response can be received from the network entities within a very short time period. When the satellite network is operating in store and forward mode (e.g.,, the feeder link is not available) and it does not have the UE context or subscription information, the UE cannot attach/register with the satellite and perform communication.

Existing mechanisms do not enable the satellite to store UE context and information so that the procedures can be executed. For delay-tolerant UEs, it may not be necessary to provide continuous services to the UE as long as service can be provided periodically. Therefore, it may not be required for all satellites to store all UEs'contexts or for all satellites to provide services to all UEs. Currently, there does not exist and method to restrict UEs from attempting to access all satellites, that are providing service in the area of the UE. Thus, the UE may try to access satellites that do not have its context and subscription information and therefore may not be able to provide service to the UE(s).

For an instance, the store and forward satellite operation as illustrated in FIG. 1A, shows the normal/default satellite operation used in 5G network with the satellite access. As illustrated in FIG. 1A and FIG. 1B, under normal/default satellite operation, the signaling and data traffic exchange between the UE with satellite access and the remote ground network requires a service and feeder links to be active simultaneously. Hence, the UE can interact with the service link of the satellite, establish a continuous connectivity path between the UE, the satellite, and the ground network.

As illustrated in FIG. 1B, using the store and forward satellite operation, the exchange of signaling/data traffic can be handled in two non-concurrent steps. In step A, signalling/data is exchanged between the UE and the satellite, without the satellite being simultaneously connected to the ground network (e.g.,, the satellite is able to operate the service link without an active feeder link connection). In step B, connectivity between the satellite and the ground network is established, so that the satellite can communicate with the ground network. Hence, the satellite moves from being connected to the UE in step A to being connected to the ground network in step B.

The store and forward operation can be used for delay-tolerant/non-real-time Internet of Things (IoT) satellite services with Non-Geostationary Satellite Orbit (NGSO) satellites. Information related to satellite coverage availability can be provisioned to the UE through a Protocol Data Unit (PDU) session or short message service (SMS).

The UEs may support store and forward operation, connected through the satellite access to the satellite. The architectural changes are required to support store and forward operations in 4G/5G network services using satellite access, which is currently not defined.

Multiple satellites can serve different UEs in the same area. Based on 3GPP standards, all satellites (belonging to the same Public Land Mobile Network (PLMN)) will broadcast the same Tracking Area Code/Tracking Area Identity (TAC/TAI) in the same location, e.g., TAC is fixed with respect to the Earth reference point. When being served by a single satellite, the UE will not be able to differentiate other satellites serving the same area. Additionally, the UE attempts to get service from all available satellites that are broadcasting the same TAC/TAI in the same area and gets rejected by the satellites other than the primary (serving/allowable) satellite of the UE.

FIG. 2 is an example scenario wherein the feeder link is not available for the satellite to communicate with a remote Data Network (DN). As illustrated, the satellite may be positioned in orbit to serve a specific geographical area on Earth, managing communication between the UE(UE1, UE2, . . . UEN) on the ground and a broader network infrastructure (remote DN). As illustrated in FIG. 2, the satellite ensures that communication between the UE and the satellite is maintained consistently, with the satellite managing the registration and service connection of the UE. As illustrated, when the feeder link is not available, the communication pathway between the satellite and the ground-based network, such as a DN or Application Function (AF), is temporarily disrupted. The feeder link is essential for the satellite to transmit data to and from the ground network. In absence of the feeder link, the satellite is unable to immediately forward any data it receives from the UE to the ground network.

FIGS. 3A and 3B depict a scenario in which the UE is allowed to avail service(s) from satellite 1, but not from satellite 2, respectively. As illustrated in FIG. 3A, the satellite 1 is orbiting the Earth and provides a communication link to a specific area on the ground, represented by a shaded region. The UE, located within this region, can establish a connection with the satellite 1 (when it is within the coverage area of the satellite 1) in time ‘t1’. The satellite 1 can maintain the connection with the UE, managing tasks, may include, but are not limited to the data transmission, signaling, and storing the context of the UE. The satellite 1 can handle the tracking area code (TAC) and satellite identification (Satellite-ID) to ensure that the UE connects to the correct satellite. As illustrated in FIG. 3B, the UE will attempt to obtain services from satellite 2, as the UE is unaware that it is not allowed to do so. The satellite 2 may not serve the UE, as the UE is not configured with the satellite 2. Additionally, the UE may not avail services from satellite 2, as is it not allowed to register/camp with the satellite 2.

Hence, there is a need in the art for solutions which will overcome the above-mentioned drawback(s), among others.

### SUMMARY

Certain example embodiments provide methods and/or systems for managing satellite communication at least by accessing at least one Network Function (NF) onboard a satellite.

Certain example embodiments may disclose methods and/or systems for storing a context of a User Equipment (UE) required for attachment to the satellite.

Certain example embodiments may disclose methods and/or systems in which the UE is configured to be served by a single satellite and perform the attachment procedure directly with the satellite.

Certain example embodiments may disclose an architecture for satellite communication network with all NFs onboard, wherein the UE is served by the single satellite and registers with only the serving satellite which hold the UE context.

These and other aspects will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

An example embodiment discloses a method for managing satellite communication using a store and forward (S&F) service with at least one network node onboard the satellite, the method comprising: determining, by a User Equipment (UE) (500), that a network supports the store and forward service; and initiating, by the UE (500), at least one Non-Access Stratum (NAS) procedure with the network, wherein the UE re-attempts the NAS signaling based on the received at least one store and forward information.

An example embodiment discloses a method for managing satellite communication comprising: determining, by a core network node (600), that at least one NAS procedure initiated by a UE cannot be completed due to at least one store and forward (S&F) operation, wherein the core network node onboard the network; and providing, by the core network node (600), at least one S&F information to the UE, wherein the at least one S&F information comprises an indication of the UE in the S&F operation, a list of Satellite Identifications (IDs), and a S&F wait timer.

An example embodiment discloses a system for managing satellite using a store and forward (S&F) service with at least one network node onboard the satellite, the system comprising: at least one processor comprising processing circuitry; a memory; and wherein the at least one processor is individually and/or collectively configured to: determine that a network supports the store and forward service; initiate at least one Non-Access Stratum (NAS) procedure by the UE with the network, wherein the UE re-attempts to provide a NAS signaling based on the received at least one store and forward information.

An example embodiment discloses a system for managing satellite using a store and forward (S&F) service with at least one network node onboard the satellite, the system comprising at least one processor individually and/or collectively configured to: determine that at least one NAS procedure initiated by a UE cannot be completed due to at least one store and forward (S&F) operation, wherein the core network node onboard the network; and provide at least one S&F information to the UE, wherein the at least one S&F information comprises an indication of the UE in the S&F operation, a list of Satellite Identifications (IDs), and a S&F wait timer.

### BRIEF DESCRIPTION OF DRAWINGS

Embodiments herein are illustrated in the accompanying drawings, throughout which like reference letters indicate corresponding parts in the various figures. The embodiments herein will be better understood from the following description with reference to the following illustratory drawings. Embodiments herein are illustrated by way of examples in the accompanying drawings, and in which:

FIGS. 1A and 1B are example diagrams illustrating the store and forward operation performed by a satellite, a User Equipment (UE), and a ground network in the satellite communication;

FIG. 2 is an example scenario wherein the feeder link is not available for the satellite to communicate with a remote Data Network (DN);

FIGS. 3A and 3B are example scenarios, wherein the UE is allowed to avail service(s) from satellite 1, but not from satellite 2;

FIG. 4 is an example diagram illustrating the architecture of the satellite communication in the Fifth Generation (5G) Core Network (5GC), according to certain example embodiments;

FIG. 5 is an example diagram illustrating the interaction of the satellite with the UE in the satellite communication, according to certain example embodiments;

FIGS. 6A and 6B are example diagrams depicting the process of handling data plane and control plane by the architecture of the satellite communication, according to certain example embodiments;

FIG. 7 is an example diagram illustrating the satellite communication of the 5GC wherein the NF Network Exposure Function (NEF) and DN onboard the satellite, according to certain example embodiments;

FIG. 8A is an example diagram illustrating the process of handling data plane, wherein the Packet Data Network Gateway (P-GW) onboard the satellite, DN-proxy is connected to the DN, according to certain example embodiments;

FIG. 8B is an example diagram illustrating the process of handling control plane, wherein the SCEF onboard the satellite, Application Function (AF) is connected to a Core Network (CN), according to certain example embodiments; and

FIG. 9 is an example flow diagram illustrating the process of managing satellite communication using the store and forward (S&F) service with at least one network node onboard the satellite and the UE, according to certain example embodiments.

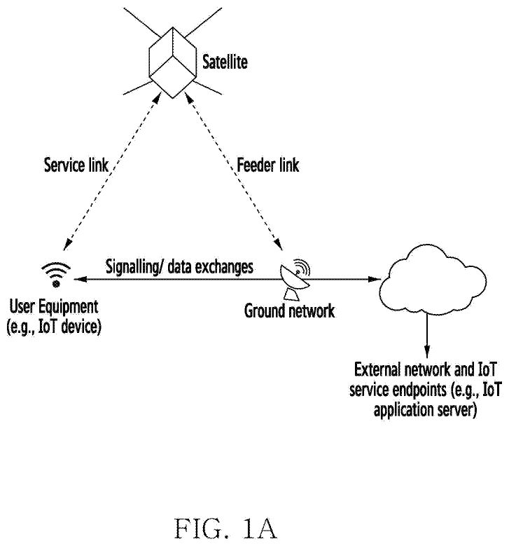

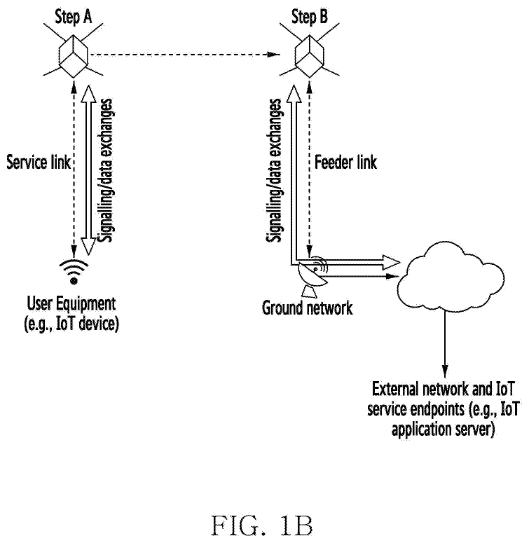

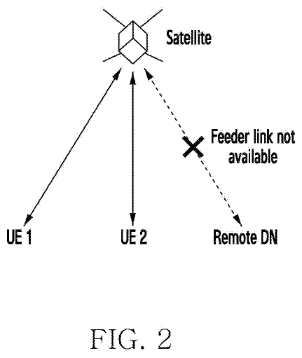

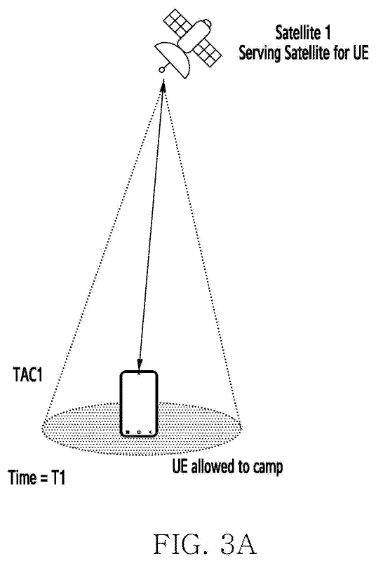

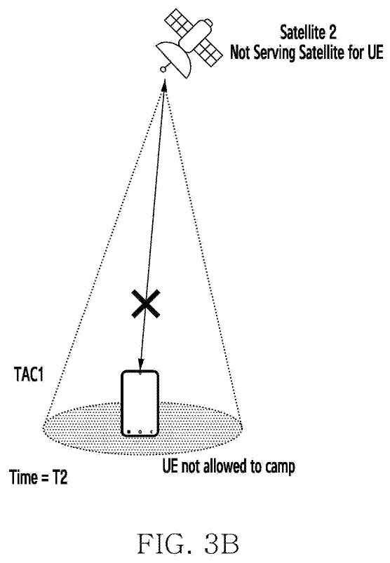

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “e.g., ,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “e.g., ,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

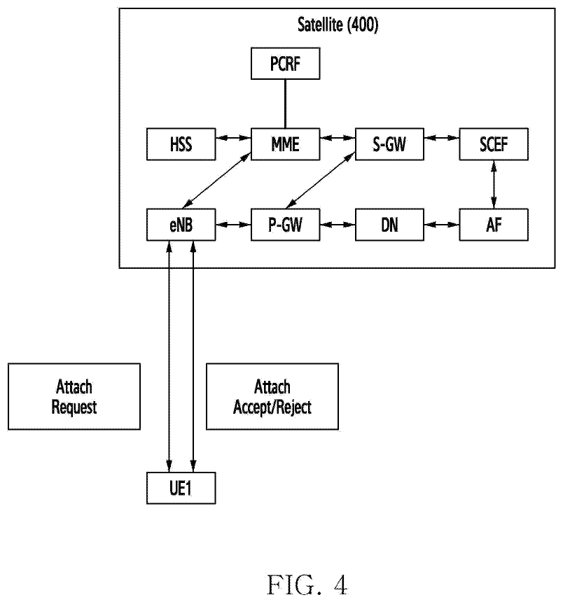

Embodiments herein disclose methods and systems for managing satellite communication by accessing at least one NF onboard a satellite. Referring now to the drawings, and more particularly to FIGS. 4 through 10, where similar reference characters denote corresponding features consistently throughout the figures, there are shown at least an embodiment.

Embodiments disclose herein disclose methods and systems for managing satellite communication by accessing at least one Network Function (NF) onboard a satellite. The satellite can store a context that is required by a UE for attachment to the satellite. In an embodiment herein, the UE can be served by a single satellite and can perform the attachment procedure directly with the satellite. Embodiments herein disclose an architecture for a satellite communication network with all NFs onboard the satellite, wherein the UE is served by a single satellite and registers only with the serving satellite that holds the context of UE.

FIG. 4 is an example diagram illustrating the architecture of the satellite communication in the Fifth Generation (5G) Core Network (5GC). As illustrated in FIG. 4, the satellite 400 comprises at least one NF (on-board the satellite). Examples of the NF can be, but are not limited to, an Evolved Node (eNodeB), a Access and Mobility Management Function (AMF), a Home Subscriber Server (HSS), a Mobility Management Entity (MME), a Serving Gateway (S-GW), a Service Capability Exposure Function (SCEF), a Packet Data Network Gateway (P-GW), a Policy Control Function (PCF), a Data Network (DN), an Application Function (AF), a Policy and Charging Rules Function (PCRF), and any other NF, which are present in terrestrial networks. This is also called as whole EPC or 5GC onboard the satellite. As illustrated in FIG. 4, the satellite 400 comprises at least one onboard NF to support a store and forward (S&F) registration procedure. These NFs can be either full-featured or lighter versions, specifically designed to handle Non-Access Stratum (NAS) procedures like attachment, registration, and service requests, without the immediate need for communication with a ground station.

The UE attempts to register or attach to the network through the satellite, and the onboard core network entities manage the procedure. The satellite may process one or more requests for attachment and registration in the store and forward mode, even when the satellite is not connected to the ground station. Therefore, the onboard core network entities store the data sent by the UE. The data is held onboard the satellite until the satellite is able to connect with the ground station, at which point the data is forwarded to the Application Function (AF) or Data Network (DN) located on the ground.

Thereby, allowing the satellite to complete the attachment process without requiring immediate assistance from the ground station. Embodiments herein enable the satellite to autonomously manage registration and communication, making it possible to handle these tasks in remote areas or during periods when there is no direct connection between the satellite and the ground station. The satellite performs autonomous operations, where the satellite can manage registration and other NAS procedures independently, and can store and forward data, ensuring communication continuity even when the satellite-ground connection is intermittent.

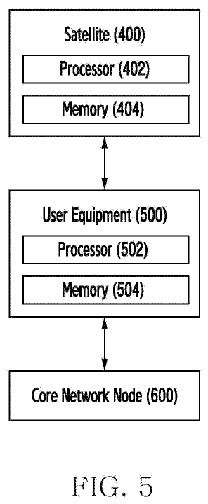

FIG. 5 is an example diagram illustrating the interaction of the satellite with the UE in satellite communication. As illustrated in FIG. 5, the satellite can interact with the UE using satellite communication, wherein the satellite 400 comprises a processor 402 and a memory 404, and the UE 500 comprises a processor 502, and a memory 504.

The term “satellite” represents at least one of the NFs or gNB/eNB that is onboard from a 3GPP perspective. For example, when the UE sends data to the satellite, it implies that data is sent to one of NFs or gNB (generally a node of the 3GPP system) that is onboard the satellite. Similarly, when the satellite sends the data, one of the NFs or gNB (generally a node of the 3GPP system) onboard the satellite can send data to the UE or to the NF/3GPP node on the ground.

The term “satellite access” can be applicable to both 5G networks and/or 4G networks, or Radio Access Technology (RAT). The terms “satellite 3rd Generation Partnership Project (3GPP) access”, “satellite access”, “satellite access network”, “NR satellite access network”, “satellite Next Generation Radio Access Network (NG-RAN) Access Technology”, and “NR satellite access” are used interchangeably and have the same meaning.

In an embodiment as disclosed herein, the satellite architecture is applicable to, may include, but are not limited to, a Satellite Evolved Universal Terrestrial Radio Access Network (E-UTRAN) access Technology, a Narrowband (NB)-S1 mode, a Wideband (WB)-S1 mode via Satellite E-UTRAN access, a Narrowband Internet of Things (NB-IoT), and a Wideband Internet of Things (WB-IoT) Satellite Access/Architecture.

The satellite architecture, as defined for NR (5G Core Network) is applicable to, may include, but are not limited to, legacy RATs like Evolved Universal Terrestrial Radio Access (E-UTRA)/Long-Term Evolution (LTE), with the corresponding Core Network (CN) entities needing to be replaced by LTE entities, such as an Access and Mobility Management Function (AMF) with the Mobility Management Entity (MME)/AMF, a gNodeB (gNB) with eNodeB (eNB), and a Unified Data Management (UDM) with Home Subscriber Server (HSS), so on.

The term “store and forward operation” refers to an operation mode in the 5G network, wherein the network can provide some level of service (by storing and forwarding data) when satellite connectivity is intermittently/temporarily unavailable. For example, the operation mode can provide communication service for UEs under satellite coverage without a simultaneous active feeder link connection to the ground segment.

The UE 500 referred to herein may be an electronic device/user device that is used by the user to connect, interact, and/or control the operations of the plurality of other devices using a 3GPP network. Examples of the UE 500 may include, but are not limited to, a smartphone, a mobile phone, a video phone, a computer, a tablet personal computer (PC), a laptop, a wearable device, a personal digital assistant (PDA), an IoT device, or any other device that may use a 3GPP network.

The processor 502 may include one or a plurality of processors. The one or a plurality of processors may be a general-purpose processor, such as a central processing unit (CPU), an application processor (AP), or the like, a graphics-only processing unit such as a graphics processing unit (GPU), a visual processing unit (VPU), and/or an Artificial Intelligence (AI)-dedicated processor such as a neural processing unit (NPU).

The memory 504 referred herein include at least one type of storage medium, from among a flash memory type storage medium, a hard disk type storage medium, a multi-media card micro type storage medium, a card type memory (for example, an SD or an XD memory), random-access memory (RAM), static RAM (SRAM), read-only memory (ROM), electrically erasable programmable ROM (EEPROM), programmable ROM (PROM), a magnetic memory, a magnetic disk, or an optical disk.

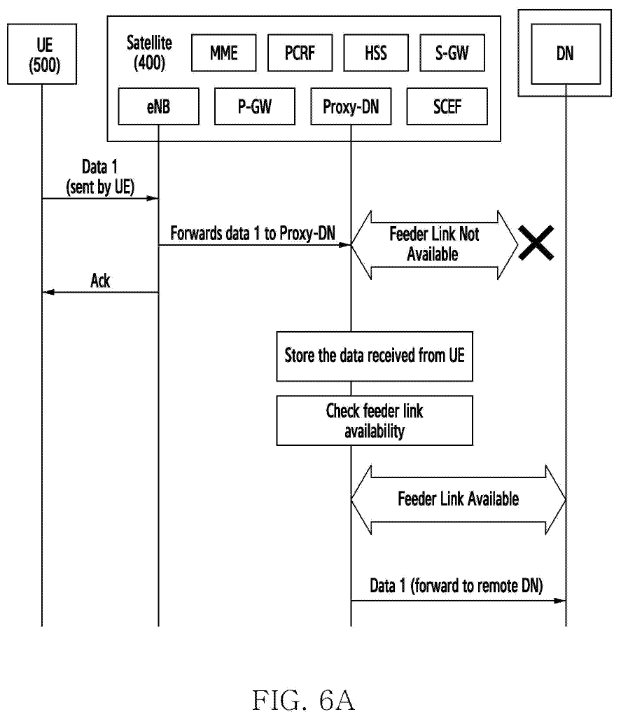

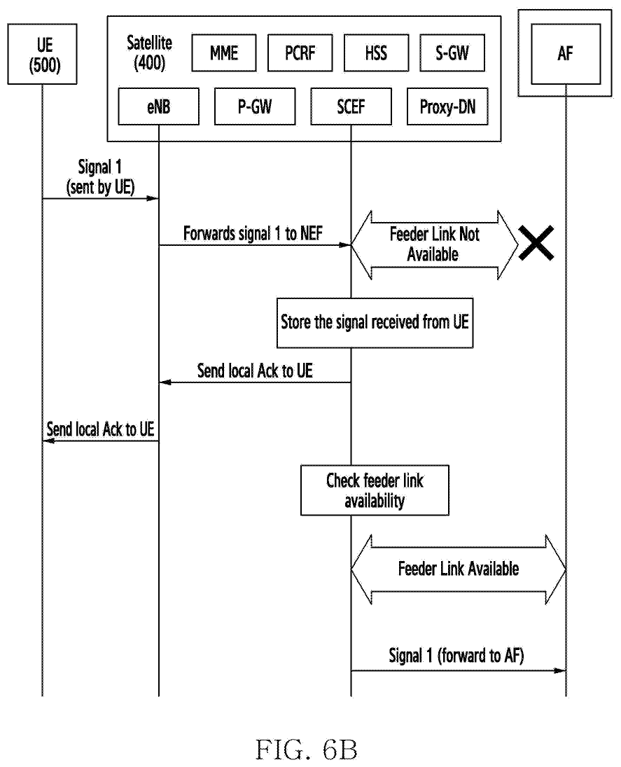

FIGS. 6A and 6B are example diagrams depicting the process of handling the data plane and control plane by the architecture of satellite communication. As illustrated in FIG. 6A, the data plane refers to the user data, which is transmitted from the UE 500 to the DN through the satellite 400. As illustrated in FIG. 6A, the satellite 400 comprises one or more NFs, which may include, but are not limited to, the MME, the AMF, the PCRF, the HSS, the S-GW, the NB, the P-GW, the proxy-DN, the SCEF, and so on.

The core network node such as NF (eNB, onboard the satellite) on receiving the user data from the UE 500, can transmit the received data to the proxy-DN. The satellite 400, on identifying that the feeder link (the communication link between the satellite and the DN) is not available, the satellite stores the data received from the UE. The proxy-DN can store the user data while the feeder link is unavailable.

The feeder link refers to communication pathway between the satellite (which hosts various core network functions) and the ground-based Data Network (DN) or Application Function (AF). The feeder link is essential for transmitting data between the satellite and terrestrial networks, enabling the flow of information from the User Equipment (UE) to the broader network infrastructure.

The satellite 400 continuously checks for the availability of the feeder link. On identifying that the feeder link is available, the satellite 400 can transmit the data stored on proxy-DN to the Data Network (DN). Therefore, the process ensures that the data received from the UE is not lost and is transmitted to the DN as soon as the feeder link is available. The proxy-DN, on the satellite 400 provides data buffering and proxying, allowing the satellite to manage the data transmission effectively despite potential link unavailability. Hence, the architecture is used in satellite communications, where connectivity to the ground networks can be intermittent.

The onboard NF, Proxy-DN can manage the data flow, when the direct communication with the DN is temporarily unavailable. Therefore, ensures that the user data is efficiently and securely handled, in satellite communications.

As illustrated in FIG. 6B, the signal is transmitted from the UE to the Application Function (AF) through one or more NFs of the satellite 400. The satellite hosts several key network functions, which may include, but are not limited to the eNB (gNodeB), the AMF, the MME, the PCRF, the HSS, the S-GW, the P-GW, the SCEF, the Proxy-DN, and so on. On receiving the signal from the UE 500, the satellite 400 may forward the received signal to the eNB.

The satellite 400, on identifying if the feeder link (the communication link between the satellite and the AF) is unavailable, stores the signal received from the UE 500. The satellite 400 continuously checks the availability of the feeder link. The satellite 400, on identifying that the feeder link is available, transmits the stored signal from the satellite to the AF.

The architecture is designed to ensure that signals/messages/data from the UE are not lost due to temporary unavailability of the feeder link. The satellite 400, on identifying that the feeder link is restored, may transmit the store and forward signals to the AF. Therefore, the architecture may enable the reliable communication even in environments where connectivity may be intermittent.

In this embodiment the term signals refers to at least one of the signaling message e.g. NAS/AS signaling message or the user data(also called as data/application data)

In an embodiment as disclosed herein, the architecture for Evolved Packet System (EPS), with the onboard network entities/NFs may comprise a proxy Data Network on board the satellite to store the data received from the UE or data to be sent to the UE.

The NFs on board the satellite ensure that all UE contexts and timers are handled by the same satellite. The UE can perform attach or other NAS procedures without the satellite needing to connect to the ground station. When the feeder link is not available, any of the CN entities (on board the satellite, e.g., S-GW/P-GW) store the data received from the UE. If both the feeder link and service link are available, the S-GW or another entity on board the satellite forwards/sends the data received from the UE to the P-GW or actual Data Network (Remote DN) on the ground e.g., to the entities available on the ground network.

The CN entity, which stores the data on the satellite, also forwards the data it has saved earlier to the actual DN on the ground (either directly or via the P-GW) once the feeder link is available. Similarly, any signaling data (control plane data) sent by the UE for the AF on the ground may be stored by any of the CN entities on board the satellite in the absence of a feeder link. The CN entity, which has stored the signal/data, delivers the stored messages to the ground station (AF situated on the ground) once the feeder link is established.

For Mobile Terminated (MT) data or signals, the ground network can store the data until the feeder link is established. On establishing the feeder link, the stored data is sent to the satellite (e.g., to the core network entities for e.g. MME, S-GW, P-GW etc), where the respective entity stores the data for the UE in the absence of the service link (e.g.,, a link between the satellite and the UE). On the service link with the UE being available and being successfully established, the satellite sends the stored data or signal to the UE.

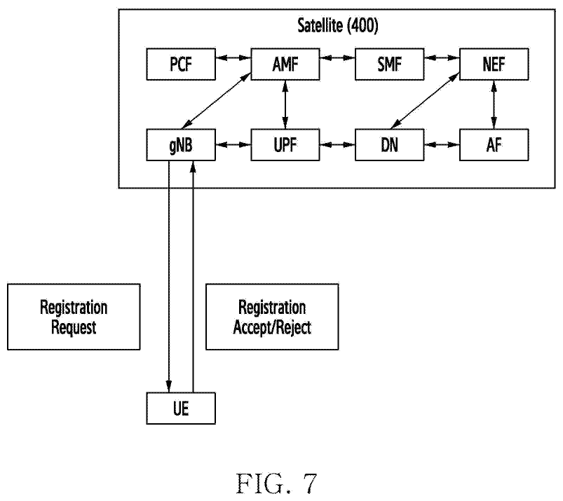

FIG. 7 is an example diagram illustrating the satellite communication of the 5GC wherein the NF Network Exposure Function (NEF) and DN onboard the satellite. As illustrated in FIG. 7, in an embodiment, the satellite 400 comprises one or more NFs. As illustrated in FIG. 7, the NF, UPF, which are on-board the satellite, retain the IP address of the UE. The DN and AF, which are on-board the satellite, can terminate the data/signal generated by the UE. The AMF onboard the satellite, can maintain the security and mobility context of the UE.

The satellite 400 comprises one or more onboard NFs to support the store and forward (S&F) registration procedure. The NFs may have full capability or be lighter versions, with the necessary capabilities to handle registration and other NAS/AS procedures on board. Any suitable NF or a new entity can store the data sent by the UE before delivering it to the ground station (Application Function or Data Network). The onboard User Plane Function (UPF) can retain the IP address of the UE. The onboard AMF can maintain the security and mobility context of the UE. All the onboard core network entities help to complete the attachment process without assistance from the ground station.

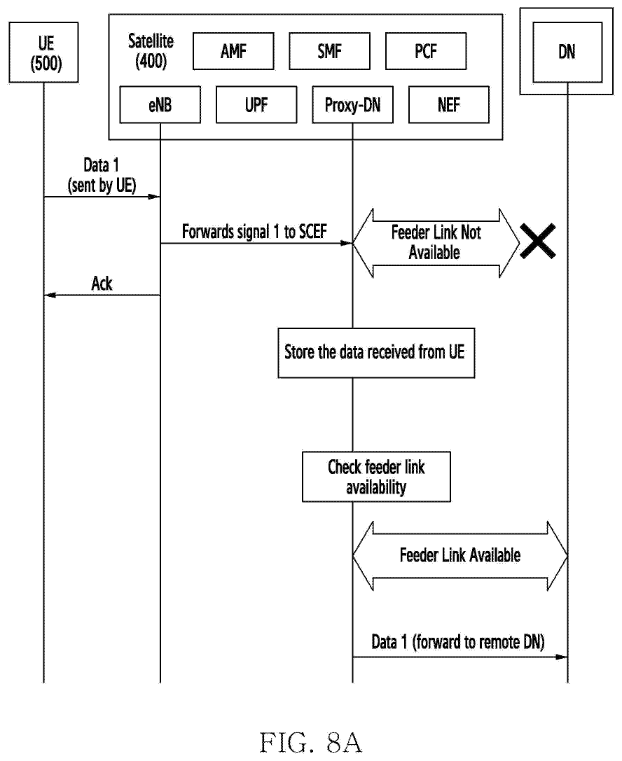

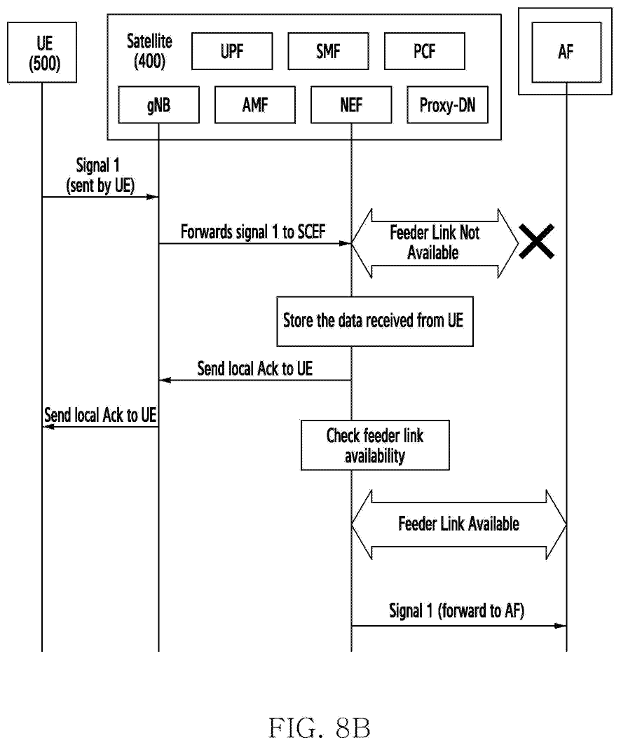

FIG. 8A is an example diagram illustrating the process of handling data plane, wherein the onboard Packet Data Network Gateway (P-GW), and DN-proxy are connected to the DN. As illustrated in FIG. 8A, the UE 500 may transmit data to the DN through the satellite 400. The satellite 400, comprises one or more NFs. As illustrated in FIG. 8A, the eNB is responsible for the radio communication with the UE 500. The eNB connects the UE 500 to the core network, facilitating communication with the various network functions hosted on the satellite.

On receiving data from the UE, the satellite 400 checks for the availability of the feeder link to communicate with the DN. On identifying that the feeder link is not available, a proxy-DN (e.g.,, a DN onboard the satellite 400) may store the received data from the UE 500. Further, the satellite 400 can continuously check for the availability of the feeder link. Hence, the temporary storage of data from the UE serves as a temporary measure to ensure that the data is not lost while waiting for the feeder link to become available. The architecture provides the process of checking feeder link availability and storing the data when the link is down for maintaining the reliable satellite communication, especially in environments of intermittent connectivity. Hence, when the feeder link is unavailable, the satellite temporarily stores the data to ensure that the data be transmitted, on re-establishing the connection. Therefore, the process helps in maintaining the continuous service in satellite-based communication.

FIG. 8B is an example diagram illustrating the process of handling control plane, wherein the SCEF onboard the satellite, Application Function (AF), is connected to a Core Network (CN). As illustrated in FIG. 8B, the UE 500 may transmit the signal to the AF through the satellite 400. The satellite 400, comprises NF, which may include, but are not limited to the UPF, the SMF, the PCF, the gNB, the AMF, the NEF, the proxy DN and so on. As illustrated in FIG. 8B, the gNB is responsible for the radio communication with the UE 500. The gNB connects the UE 500 to the core network, facilitating communication with the various network functions hosted on the satellite.

When the feeder link is unavailable, the satellite 400 cannot immediately transmit the signal, received from the UE 500 to the DN or AF, so the satellite 400 temporarily stores the signal in the NEF. This storage ensures that no information is lost during the period when the feeder link is down. The NEF may send a local acknowledgement to the UE. The NEF serves as an interface that exposes network services and capabilities to external application(s) (for example, DN, AF, and so on).

The satellite 400 continuously checks for the availability of the feeder link. The satellite 400, on identifying that the feeder link is available, the signal stored on the NEF is transmitted to the AF. Therefore, the process ensures that the data/signal received from the UE is not lost and is transmitted to the DN/AF as soon as the feeder link is available. Thereby, maintaining continuity of the service and communication.

Availability of the feeder link can directly affect the ability of the satellite 400 to communicate with the ground-based network components, while the NEF manages and exposes the core network's capabilities to external services, ensuring that these services can operate effectively even in environments where connectivity might be disrupted.

In an embodiment as disclosed herein, the architecture of the satellite in the 5G communication network may comprise a proxy Network on board the satellite to store data received from the UE or data to be sent to the UE.

All network functions (e.g., AMF and UDM) on board the satellite ensure that all UE contexts and timers are handled by the same satellite. The UE can perform registration or other NAS procedures without the satellite needing to connect to the ground station. When the feeder link is not available, one or more of the NFs (on board the satellite, e.g., UPF/NEF/SMF) store the data received from the UE. If both the feeder link and service link are available, the gNB/UPF/NEF or another NF on board the satellite forwards/sends the data received from the UE to the P-GW or actual Data Network (Remote DN) or any other entities which are on the ground.

The NF can store data on the satellite, and can forward the data that the NF has previously saved (which had been received from the UE(s)) to the DN on the ground (either directly or via the UPF) once the feeder link is available.

Similarly, any signaling data (control plane data) sent by the UE for any application function on the ground may be stored by any of the NFs on board the satellite in the absence of a feeder link. The NF, which stored the signal/data, can deliver the stored messages to the ground station (e.g., the AF situated on the ground), on establishing the feeder link.

For MT data or signals, the ground network stores the data by any of the NFs or core network entities until the feeder link is established. On establishing the feeder link, the stored data is sent to the satellite, where the respective NF stores the data for the UE in absence of the service link. On reaching location of the UE and a service link being successfully established, the satellite can send the stored data or signal to the UE.

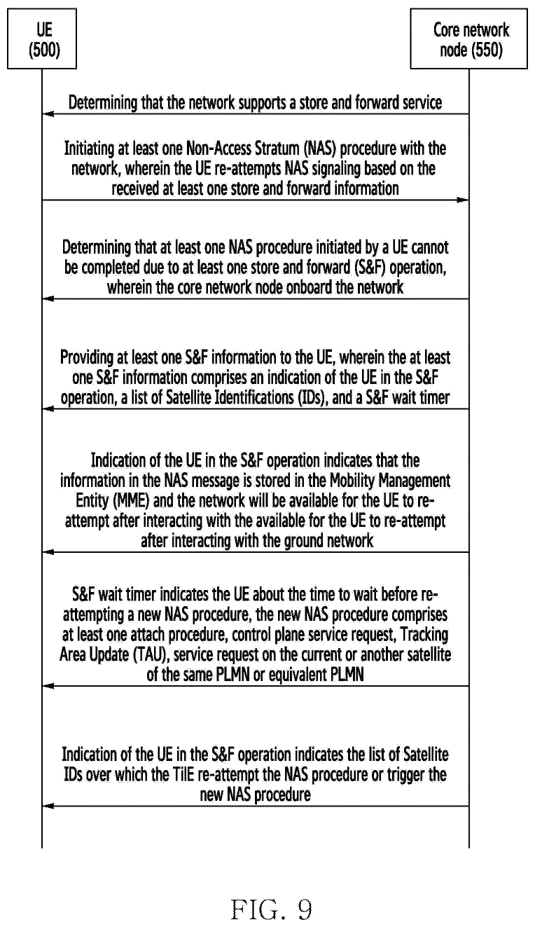

FIG. 9 is an example flow diagram illustrating the process of managing satellite communication using the store and forward (S&F) service with at least one network node onboard the satellite and the UE.

As illustrated in FIG. 9, the method for managing satellite communication using the store and forward (S&F) service with at least one network node onboard the satellite, the method comprising: determining, by a User Equipment (UE) (500), that a network supports the store and forward service; and initiating, by the UE (500), at least one Non-Access Stratum (NAS) procedure with the network.

Further, the method comprises: determining by a core network node (600), that at least one NAS procedure initiated by a UE cannot be completed due to at least one store and forward (S&F) operation, wherein the core network node onboard the network; and providing, by the core network node (600), at least one S&F information to the UE, wherein the at least one S&F information comprises an indication of the UE in the S&F operation, a list of Satellite Identifications (IDs), and a S&F wait timer. S&F operation is the store and forward satellite operation, in which a UE (500) is provided with the level of service, by storing and forwarding the data or NAS signaling for a period of time and/or geographical location in which the satellite serves the UE through a service link. The indication of UE (500) in the S&F operation indicates that at least one NAS procedure cannot be completed in the UE due to the S&F Satellite operation and that the UE can re-attempt at least one NAS procedure in the Public Land Mobile Network (PLMN) during example next satellite pass. The indication of the UE (500) in the S&F operation indicates that the information in the NAS message is stored in the Mobility Management Entity (MME) or any other core network node onboard the satellite and the network will be available for the UE to re-attempt after interacting with the ground network for e.g. once the network entity onboard the satellite is able to fetch the UE context like AV required for authentication procedure or subscription data from HSS/UDM. The S&F wait timer indicates the UE about the time to wait before re-attempting a new NAS procedure, the new NAS procedure comprises at least one attach procedure, control plane service request, Tracking Area Update (TAU), service request on the current or another satellite of the same PLMN or equivalent PLMN. The indication of the UE in the S&F operation indicates the list of Satellite IDs (also called as monitoring list) over which the UE can re-attempt the NAS procedure or trigger the new NAS procedure. The UE is configured to attempt on the list of Satellite IDs, on identifying the wait time expiry. The UE determines the Satellite IDs based on the System Information Block (SIB) broadcasted by an evolved Node B (eNB) or gNB or any RAN node. e.g., the UE determines the cells which are broadcasting the list of satellite IDs which are allowed for the UE, once the UE selects the allowed list of satellite IDs the UE selects and attempts the NAS signaling on the allowed satellite IDs. The NAS signaling comprises at least one attach procedure, a registration procedure, a service request procedure, and a detach procedure etc. The core network node onboard the satellite comprises at least one of Next Generation Node B (gNB), an Access and Mobility Management Function (AMF), a Mobility Management Entity (MME), a Serving Gateway (S-GW), a User Plane Function (UPF), a Policy Control Function (PCF), a Network Exposure Function (NEF), and a Proxy Data Network (Proxy-DN). The UE detaches from an Access Stratum (AS) and a Non-Access Stratum (NAS), on entering a power-saving mode. A system for managing satellite using a store and forward (S&F) service with at least one network node onboard the satellite, the system comprising: a processor (402); a memory (404); and wherein the processor (402) is configured to: determine that a network supports the store and forward service; initiate at least one Non-Access Stratum (NAS) procedure by the UE with the network, wherein the UE re-attempts a NAS signaling procedure based on the received at least one store and forward information. A system for managing satellite using a store and forward (S&F) service with at least one network node onboard the satellite, the system comprising: determine that at least one NAS procedure initiated by a UE cannot be completed due to at least one store and forward (S&F) operation, wherein the core network node onboard the network; and provide at least one S&F information to the UE, wherein the at least one S&F information comprises an indication of the UE in the S&F operation, a list of Satellite Identifications (IDs), and a S&F wait timer. The system wherein at least one S&F operation is the store and forward satellite operation, in which a UE is provided with the level of service, by storing and forwarding the data or NAS signaling for a period of time and/or geographical location in which the satellite serves the UE through a service link. The system wherein the indication of UE in the S&F operation indicates that at least one NAS procedure cannot be completed in the UE due to the S&F Satellite operation and that the UE can re-attempt at least one NAS procedure in the Public Land Mobile Network (PLMN) during next satellite pass. The system wherein the indication of the UE in the S&F operation indicates that the information in the NAS message is stored in the Mobility Management Entity (MME) and the network will be available for the UE to re-attempt after interacting with the ground network. The system wherein the S&F wait timer indicates the UE about the time to wait before re-attempting a new NAS procedure, the new NAS procedure comprises at least one attach procedure, control plane service request, Tracking Area Update (TAU), service request from the current or another satellite of the same PLMN or equivalent PLMN. The system wherein the indication of the UE in the S&F operation indicates the list of Satellite IDs over which the UE re-attempt the NAS procedure or trigger the new NAS procedure. The system wherein the UE is configured to attempt on the list of Satellite IDs, on identifying the wait time expiry. The system wherein the UE determines the Satellite IDs based on the System Information Block (SIB) broadcasted by an evolved Node B (eNB). The system wherein the NAS signaling comprises at least one attach procedure, a registration procedure, a service request procedure, and a detach procedure. The system wherein the core network node onboard the satellite comprises at least one of Next Generation Node B (gNB), an Access and Mobility Management Function (AMF), a Mobility Management Entity (MME), a Serving Gateway (S-GW), a User Plane Function (UPF), a Policy Control Function (PCF), a Network Exposure Function (NEF), and a Proxy Data Network (Proxy-DN). The system wherein the UE detaches from an Access Stratum (AS) and a Non-Access Stratum (NAS), on entering a power-saving mode.

In another embodiment as disclosed herein, the rotation of satellites around the Earth follows a predictable, pre-determined path. Due to this predictable rotation, the satellite will pass over a selected area on Earth at specific time intervals. The satellite can be restricted to serve only in one or more specific areas, at specific times, or a combination of area and time. The area can be defined by a tracking area code (TAC), a geographical area, etc. Consider that an area or location has only one serving satellite, and all UEs (User Equipment) in that respective area are served by the same satellite. The satellite serving the UEs in this area (Area 1) will store the contexts of all UEs being served by this satellite in that area. Other satellites may be available to serve in different areas, at different times, or for a combination of area and time, to UEs different from those in Area 1. The satellite broadcasts its services, such as Master Information Block and System Information Block (MIB/SIB), and any other parameters only in the area, time, or combination of area and time it is allowed to serve.

In other areas or times, the satellite will switch off its broadcast, and it will not serve any UEs in the areas, times, or combinations of area and time where it is not allowed to serve, except for emergency services. The satellite may also switch off or disable its NAS/AS or disable its antennas in areas that it is not allowed to serve.

The UEs may optionally switch to power-saving mode or disable their NAS/AS, when the satellite serving the UEs is not available in the area. The satellite will serve the UEs for the flyover duration (the duration during which the service link with the UEs may be maintained or established) only once per rotation around the Earth, in a given area, at a specific time, or combination of area and time.

In another example, consider that the UE (UE1) is in an area ‘a’ (geographical area) at time ‘t’. A satellite (Satellite S) serves area ‘a’ at time ‘t’. The UE1 registers with Satellite S. When the satellite moves to a new location, e.g., an area other than area ‘a’, the satellite switches off its broadcast/NAS/AS/antennas e.g., the network may switch off e.g., detach/deregister the UE. When the satellite has an available feeder link, the satellite connects and delivers the data/signaling sent by the UE1 to the DN/AF/any other NFs on the ground. When Satellite S returns to area ‘a’ after orbiting around the Earth, it switches on its broadcast/NAS/AS/antennas again. Therefore, ensuring that Satellite S broadcasts its signals only in area ‘a’, and only the allowed UEs of area ‘a’ connect/camp/register/attach to the same satellite S every time.

In another embodiment as disclosed herein, multiple (say ‘n’) satellites may serve in a particular area. All satellites serving in the area will broadcast different identifiers. The UEs will be configured to attach/register/camp only on the allowed satellite broadcasting specific identifier(s). Examples of the identifiers can be, but not limited to, the PLMN ID, the TAI, the TAC, the Cell-ID, the gNB-ID, satellite IE or any combination thereof. The UE may be provided or be configured with a list of allowable identifiers in the registration accept/attach accept or any other NAS or AS message signal. Alternatively, the UE may be provided with a list of forbidden or disallowed identifiers in the registration accept/reject or attach accept/reject or any other NAS/AS message signal.

The UE should not attempt to register/attach/camp or receive service from a satellite broadcasting an identifier that is in the forbidden/disallowed identifier list, or not present in the allowable identifier list.

The satellite may serve the UE for the flyover duration (the period during which the service link with the UE may be maintained/established) only once per rotation around the Earth. For an instance, consider that a plurality of satellites (1, 2, . . . N) are serving an area. The satellites are broadcasting Tracking Area Codes (TAC) as TAC1, TAC2, . . . TACN. A UE (UE1) registers/attaches with satellite 1 and receives an allowable TAC list with TAC1 and a forbidden TAC list with TAC2, TACN, etc. The UE can send/receive data through satellite 1, and broadcasting the allowable TAC (TAC1). When satellite 1 is not available (e.g., TAC1 is not broadcasted), the UE does not attempt to camp/register with any other satellite broadcasting TAC2, TACN, etc. The satellite 1, on reaching the location of the UE after orbiting around the Earth, can broadcast the TAC1. On receiving the TAC1, the UE checks for the TAC1 broadcast again and registers/attaches/camps with it.

In another embodiment as disclosed herein, the satellite may broadcast and provide service all the time, and multiple satellites may broadcast the same identifier (PLMN ID, Cell ID, TAC, TAI, area, gNB ID, or any combination of these) at the same location, either at the same or different times. The UEs will be configured to attach, register, or camp only at specific time or within a specific time range to the satellite broadcasting a particular identifier. This specific time or time range may be configured in the UE so that the same satellite, which stores the UE context, serves the location of UE. Thus ensuring that the UE can register, attach, or camp to the same satellite storing the UE context.

The UE may be provided with a list of allowable identifiers, along with the allowable time(s), in the registration accept, attach accept, or any other NAS/AS message signal. The UE will maintain a list of the identifiers along with the allowable times or time ranges.

In another embodiment herein, the UE may be provided with a list of forbidden or disallowed identifiers, optionally along with the forbidden time(s), in the registration accept, attach accept, or any other NAS/AS message signal. The UE will maintain a list of forbidden identifiers along with the forbidden time(s) range. The UE will not attempt to register, attach, camp, or receive service from a satellite, when the UE is not allowed to camp on the given identifier, except for emergency services. The UE may add the identifier to the forbidden identifier list, other than the allowable time(s) ranges. When the UE is allowed to camp, attach, register, or receive services from the satellite, the UE will remove the identifier from the forbidden or disallowed list and optionally, add the identifier back to the allowable list.

The UE will attempt to register, attach, or trigger any other NAS/AS message when the UE is within an allowable identifier zone during the designated allowable time. The valid time for an allowable identifier, may include, but are not limited to, an absolute start time and end time, a start time and duration, or only a start time, after which the satellite informs the UE before moving out or when it will no longer be able to provide service(s) to the UE.

In an example, consider that a UE (UE1) is in an area with the identifier TAC1 (Tracking Area Code 1). Different satellites can serve the same area one after another, each broadcasting TAC1. The UE registers with a satellite (Satellite S) that serves the location of UE from the allowed time period (e.g., time ‘t1’ to time ‘t2’). During the registration or attach accept or any AS/NAS signaling procedure, the UE receives the allowable TAC or any identifier and time range as TAC1 for the time range ‘t1’ to ‘t2’, ensuring that the UE is allowed to camp only when the satellite (Satellite S) is serving at the location of UE. The UE can add TAC1 to the allowed tracking area list at time ‘t1’ and removes TAC1 from the allowed tracking area list, adding it to the forbidden tracking area list at time ‘t2’, meaning it is allowed only between ‘t1’ and ‘t2’.

In an embodiment as disclosed herein, the satellites broadcast a new ID, hereinafter referred to as the Satellite-ID. The Satellite-ID may include, but are not limited to, at least one of the Satellite-ID, the Satellite-Constellation-ID, or any other identifier, along with the identifiers (PLMN ID, TAC, TAI, Cell-ID, gNB-ID, area, etc.). The UE can attach or register with the satellite which can store its context. The UEs will be configured to attach, register, or camp only to the satellite broadcasting a specific Satellite-ID, optionally only from the configured identifier list during the registration procedure. The UE may be provided with a list of allowable Satellite-IDs, optionally along with allowable identifiers, in the registration accept/attach accept or any other NAS/AS message signal.

In another embodiment herein, the UE may be provided with a list of forbidden or disallowed Satellite-IDs, optionally along with forbidden or disallowed identifiers, in the registration accept/attach accept or any other NAS/AS message signal. The UE may not attempt to attach, register, or camp on a satellite with a Satellite-ID that is not in the allowable list or is present in the forbidden/disallowed list, except for emergency services. The UE will attempt to camp, register, or send a NAS/AS message to the network only from an allowable Satellite-ID.

The satellite will serve the UE for the flyover duration (the period for which the service link with the UE may be maintained or established), only once per rotation around the Earth. For an instance, the UE (UE1) is in an area with TAC1 (Tracking Area Code 1). Satellites can broadcast a Satellite-ID. Different satellites serve this area one after another, each broadcasting a different Satellite-ID. The UE registers with a satellite broadcasting Satellite-ID S1. In the registration or attach accept message, the UE receives the allowable Satellite-ID S1. Hence, ensuring that the UE is allowed to camp only when the satellite is broadcasting Satellite-ID S1. The UE can add Satellite-ID S1 to the allowed Satellite-ID list.

Therefore, embodiments herein can handle store and forward communication for UEs through satellite access for both EPS and 5GS. The UE can register or attach to the satellite without assistance from the ground station, allowing the attach process to be performed even when the feeder link with the ground station is not available. Hence, providing a method to restrict delay-tolerant UEs to a single satellite(s) by maintaining and syncing context across different satellites.

In an embodiment as disclosed herein, the UE may determine that it is in NR/Evolved Universal Terrestrial Radio Access Network (E-UTRAN) Satellite Access Discontinuous Coverage for a selected PLMN or network. The location of the UE can be determined, which may include, but are not limited, to start of the unavailability period and/or unavailability period duration, as determined by the UE, indicated by the network (e.g., by any network function such as, but not limited to, AMF, Mobility Management Entity (MME), etc.) or negotiated between the UE and the network. For an instance, if the current time is after the start time and the unavailability period duration is not over, the UE may determine that it is in discontinuous coverage, optionally for the selected PLMN or network. The determination can also be based on the unavailability type, which indicates that the unavailability period is due to NR/E-UTRAN Satellite Access Network discontinuous coverage. Alternatively, it may be based on any of the network broadcast parameters or messages, or any network indication (such as SIB-19, SIB-32).

The Application Function (AF) or the 5GC (Network Function) NF (such as AMF, Policy Control Function (PCF), Unified Data Management (UDM), or any other NF, etc.) can provide Satellite Coverage Availability Information (SCAI) to the UE based on entity, which may include, but are not limited to, the Satellite Coverage Availability Function (SCAF), and so on.

In another embodiment herein, the UE can determine that it is in discontinuous coverage of the network using at least one of the methods, which may include, but are not limited, a broadcast parameter, a SIB parameter, a NAS signaling parameter, an AS signaling parameter, information regarding configuration for NTN deployment as configured in the UE, information regarding configuration for NTN deployment as indicated by the network, an unavailability period duration and a start of the unavailability period, an unavailability type, an indication for Store and Forward mode, satellite coverage availability information (SCAI), satellite ephemeris information, information regarding configuration for NTN deployment as configured in a SIM, information regarding configuration for NTN deployment as indicated by a server, information regarding configuration for NTN deployment as indicated by an application function, or a database indicating details of a satellite or NTN cell, its location, its availability/unavailability time, its deployment details, and so on.

Therefore, before transmitting the registration request message, the UE receives satellite coverage availability information from an application function by determining the value of the unavailability period duration and the value of the start of the unavailability period based on the received satellite coverage availability information.

The method may include receiving unavailability information due to discontinuous coverage by the network, when the UE initiates an AS/NAS signaling procedure. The unavailability information comprises at least one of the start of the unavailability period, the unavailability period duration, and the unavailability type. The unavailability type may be set to unavailability due to discontinuous coverage. The unavailability information can be sent as part of a registration request procedure, a mobility registration update procedure, an attach procedure, a tracking area update procedure, or a service request procedure.

Discontinuous coverage indicates a period of no service for the UEs, followed by a period of service availability for the UEs. For example, a UE may be in satellite coverage from 10 AM to 1 PM, and later at 1 PM, the UE may enter discontinuous coverage, meaning no service. After a certain period, for instance, 3 hours, the UE may regain service via satellite access. This occurs because the satellite serving the area may have moved to the next location, leaving the current location without coverage from another satellite.

In Non-Terrestrial Networks (NTN), continuous satellite coverage is determined based on the interface that is available for the UE at a given position of the time. In contrast, in NTN, discontinuous satellite coverage is determined based on an interface that is available for the UE at a given position for less than 100% of the time, due to the predictable lack of satellite coverage. As a result of discontinuous coverage, the UE may have access to satellite service coverage only at specific time and location.

Examples of the NTN, may include, but are not limited to, a Low Earth Orbit (LEO), a Medium Earth Orbit (MEO), a Geostationary Orbit (GEO), a High Altitude Platform Systems (HAPS), a Unmanned Aerial Vehicle (UAV), a Unmanned Aircraft System (UAS), a network supported by an airborne vehicle, a network deployed using the 3rd Generation Partnership Project (3GPP) Satellite or NTN system, an NTN network deployed using at least one 3GPP technology (e.g., a 3GPP-based satellite system or an NTN network deployed using an LTE network), or an NTN network deployed using at least one NTN implementation outside the scope of the 3GPP NTN system (e.g., an NTN deployed using an operator server or application).

The terms used in the embodiment “NTN”, “3GPP-based Satellite Network”, “Satellite 3GPP Access”, “Satellite Access”, “Satellite Access Network”, “NR Satellite Access Network”, “Satellite NG-RAN Access Technology”, “NR Satellite Access”, “LTE Satellite Access Network”, “Satellite E-UTRAN Access Technology”, and “LTE Satellite Access” may be interchangeably used and have the same meaning.

As used herein, “presence of the UE in an NTN-only coverage area” may refer to a situation where only a non-terrestrial network is available at the location of the UE, or where there are both NTN and terrestrial networks available, but the terrestrial networks are not suitable or allowable for the UE to receive normal services.

As used herein, an “allowable network” for the UE refers to networks that are not part of any back-off network list, forbidden network list, or temporary back-off/forbidden network list of the UE. It may refer to a network on which the UE is allowed to camp or register in order to receive normal or full services.

In an embodiment herein, the UE may identify the availability of an NTN. The UE can identify a network deployed by the network operator using one or more of the NTN technologies, by identifying one or more parameters associated with deploying the NTN technology, or by identifying one or more pieces of information associated with deploying the NTN technology. The identification can be performed based on an agreement between a network operator, an NTN vendor, and the UE, or the UE can determine the network information (such as cell, band, frequency, RAT, PLMN, access, etc.) on which the NTN is deployed using an indication from the network, an indication from any servers, or pre-configured information in the UE. The UE may identify the deployment of the NTN technology based on the identification, determination, or reception of one or more parameters. The parameters may include a broadcast parameter, a System Information Block (SIB) parameter, Non-Access Stratum (NAS) signaling parameters, and Access Stratum (AS) signaling parameters.

In an embodiment herein, the UE may identify the availability of a NTN based on network parameters and conditions, which may include, but are not limited, a band used by an operator or satellite vendor for deploying a satellite service, an NTN service, the PLMN, frequency, or RAT used by an operator or satellite vendor for deploying a satellite service or NTN service, and so on. The UE can also identify a network deployed using any NTN technology or a network used by a satellite vendor for deploying a satellite service or an NTN service.

The UE may also identify the availability of an NTN based on the identification or reception of one or more pieces of information associated with deploying the NTN technology. The information could include configuration details for NTN deployment in the UE, as indicated by the network, as configured in a Subscriber Identity Module (SIM), as indicated by a server, or as indicated by an application function. The information could include information from a database that contains details of a satellite or NTN cell, such as its location, availability/unavailability times, and deployment details. Additionally, the information may be generated by a machine learning or artificial intelligence model to predict or determine a network type, or it may be acquired using a data-driven technique to predict or determine a network type.

In another embodiment herein, the UE registered to the network could be registered, which may include, but are not limited to the TN, the NTN, a 3GPP network, or a Non-3GPP (N3GPP) network.

The terms “list of satellite IDs,” “allowable list of satellite IDs,” “allowable Satellite IDs,” or “list of allowable Satellite IDs” are used interchangeably and have the same meaning. The term “NTN” or “NR/E-UTRAN Satellite Access Network,” as used in this embodiment, may refer to any of the NR Satellite Access Network, E-UTRAN Satellite Access Network, NR Satellite Access Technology, or E-UTRAN Satellite Access Technology.

In another embodiment, the term “satellite” can be interchangeably used with the 5G or 4G system with satellite access and is used to represent any satellite(s) or constellation of satellite(s), or any aerial body/satellite in any of the satellite orbits (e.g., LEO, MEO, GEO, HEO), or any 5G system with satellite access, or any 4G system with satellite access, or any RAN entity, core network entity, or any network function(s) associated with satellite access, RAT, PLMN, or network.

The terms “unavailability period duration”, “unavailability period”, “discontinuous coverage”, “discontinuous coverage period”, and “unavailability duration” are used interchangeably and have the same meaning.

The terms “start time”, “start of unavailability period”, “start of unavailability duration”, “start of discontinuous coverage”, “start of discontinuous coverage period”, and “start of unavailability period duration” are used interchangeably and have the same meaning.

The terms “support of/for unavailability period” and “unavailability period support” are used interchangeably and have the same meaning.

The terms “NTN”, “3GPP-based Satellite Network”, “Satellite 3GPP access”, “Satellite access”, “Satellite Access Network”, “NR Satellite Access Network”, “Satellite NG-RAN Access Technology”, and “NR Satellite access” are used interchangeably and have the same meaning.

The terms “select”, “camp”, “register”, “attach, and “Tracking Area Update (TAU)” are used interchangeably and have the same meaning. The terms “UE”, “ME”, and “MS” are used interchangeably and have the same meaning. The terms “select”, “search”, and “scan” are used interchangeably and have the same meaning.

In another embodiment as disclosed herein, the UE may add the last selected or registered network (e.g., PLMN or RAT or Cell or Band or any combination of these) to any temporary back-off network list or forbidden network list or any back-off list while the wait timer is running. The UE may not select, search, scan, deprioritize, ignore, or scan with the lowest priority network (e.g., cell/PLMN/RAT/Access/Band/Network) present in this list.

In an embodiment herein, after the network search procedure, the UE may camp, attach, or register on any of the selected available networks. The UE may prefer to camp, attach, register, or trigger a TAU on the TN before triggering a search, or a scan for the NTN and, optionally, camping, attaching, registering, or triggering a TAU on the TN.

In an embodiment herein, the UE may perform the network search procedure and select the TN based on at least one of the following: a terrestrial PLMN, a terrestrial RAT, terrestrial access, a terrestrial system, a terrestrial RAN, a terrestrial band, a terrestrial frequency, a terrestrial cell, a terrestrial CN entity, a terrestrial network entity, a component of a terrestrial network, a terrestrial network function, a network other than NTN, and a network other than the satellite access network.

The terms “event”, “trigger event”, and “trigger conditions” are used interchangeably and have the same meaning.

In an embodiment herein, the UE can ignore the NTN based on at least one of a non-terrestrial PLMN, a non-terrestrial RAT, a non-terrestrial access, a non-terrestrial system, a non-terrestrial RAN, a non-terrestrial band, a non-terrestrial frequency, a non-terrestrial cell, a non-terrestrial CN entity, a non-terrestrial network function, a component of a non-terrestrial network, a network other than TN, and a network on the satellite access network.

In an embodiment herein, the event or trigger event, may include, but are not limited to switching off the UE, switching on the UE, recovery of the UE from a lack of coverage area, recovery of the UE from an out-of-service (OOS) area, SIM insertion in the UE, SIM reinsertion post removal in the UE, SIM removal in the UE, disabling of the SIM in the UE, enabling of the SIM in the UE, modem reset, power cycle, modem power-up, modem power cycle, airplane mode on in the UE, airplane mode off in the UE, the UE exiting airplane mode, the UE entering airplane mode, the modem exiting airplane mode, activation of the UE, reject cause from the network, a detach triggered by the network, deregistration triggered by the network, entering store-and-forward mode in the UE, exiting store-and-forward mode in the UE, entering store-and-forward mode from the network, exiting store-and-forward mode from the network, a detach triggered by the UE, deregistration triggered by the UE, a network mode change in the UE, a network selection mode change in the UE, an operating mode change in the UE, entering satellite mode in the UE, exiting satellite mode in the UE, turning on a modem, and a SIM refresh procedure.

The term “events” may also be referred to herein as “trigger conditions”, which are scenarios where the UE needs to trigger or perform a network search or selection or scanning procedure, a PLMN search or selection or scanning procedure, a cell search or selection or scanning procedure, or a RAT/access search or selection or scanning procedure.

The term “registration procedure,” as used herein, may be associated with the registration or camping of a UE in the 5G network. The term “attach procedure” refers to the registration or camping of a UE in a 4G network or Long-Term Evolution (LTE) network. “Detach” is associated with the de-registration or detaching of a UE in a 4G Network or LTE network. The term “deregistration” is associated with the de-registration or detaching of a UE in a 5G Network or NR network.

The usage of terms “camping” or “registering” to a network or network cell refers to the process by which a UE (e.g., a mobile phone, tablet, or similar device) connects to a specific cellular network and becomes associated with that network. It may also refer to a procedure where the UE has completed the cell/network selection/reselection process and has chosen a cell/network from which it plans to receive all available services. This can also include selecting a cell of the PLMN/network and completing necessary procedures (e.g., Location Registration) to access services from the network.

The term “Network” in this embodiment may refer to any PLMN, RAT, Access, Access Technology, Cell, Satellite, or any combination of these. The term “network” may refer to one or more of the following: a Public Land Mobile Network (PLMN), a Radio Access Technology (RAT), an access or system, a Radio Access Network (RAN), a band, a frequency, a cell, a network entity, a Core Network (CN) entity, a network function, any terrestrial network, any non-terrestrial network, or any component of the network.

In the embodiment as disclosed herein, the network can comprise a 5G Core Network Function, such as AMF. The network can further include one or more 5G/EUTRAN Core Network Entities, which may include, but not limited to, AMF, SMF, MME, UPF, UDM, or 5G/EUTRAN RAN Entities (like eNodeB (eNB), gNodeB (gNB), or NG-RAN).

The term “network,” as used herein, may include, but are not limited to, a Public Land Mobile Network (PLMN), a Radio Access Technology (RAT), an access, a system, a Radio Access Network (RAN), a band, a frequency, a cell, a network entity, a network function, any terrestrial network, any non-terrestrial network, or any component of the network.

The term “Non-Terrestrial Network (NTN),” as used herein may include, but are not limited to, a non-terrestrial PLMN, a non-terrestrial RAT, a non-terrestrial access, a non-terrestrial system, a non-terrestrial RAN, a non-terrestrial band, a non-terrestrial frequency, a non-terrestrial cell, a non-terrestrial network entity, a non-terrestrial CN entity, a non-terrestrial network function, a component of a non-terrestrial network, a network other than a terrestrial network (TN), or a network on a satellite access network.

The term “Terrestrial Network (TN),” as used herein, may include, but are not limited to, a terrestrial PLMN, a terrestrial RAT, a terrestrial access, a terrestrial system, a terrestrial RAN, a terrestrial band, a terrestrial frequency, a terrestrial cell, a terrestrial network entity, a terrestrial CN entity, a terrestrial network function, a component of a terrestrial network, a network other than NTN, or a network other than a satellite access network.

The term “User Equipment (UE),” as used herein, may include, but are not limited to, an NTN-capable UE, a UE capable of availing NTN services, a UE supporting NTN technology, a UE capable of accessing NTN services using technologies other than NTN technology, a UE capable of availing a service deployed using a 3rd Generation Partnership Project (3GPP) satellite or NTN system, a UE capable of availing a service deployed using a 3GPP system, a UE capable of availing an NTN service deployed using any 3GPP technology, a UE capable of availing an NTN service deployed using any proprietary NTN implementation outside the scope of the 3GPP NTN system, a UE with a usage setting as a voice-centric UE, a UE configured to send or receive an Attach Type as Combined International Mobile Subscriber Identity (IMSI), or a UE configured to send or receive an Attach Type as Combined IMSI with SMS only.

The terms “camping” or “registering” to a network or network cell, as used herein, refer to the process by which a UE (such as a mobile phone, tablet, or similar device) connects to a specific cellular network and becomes associated with that network. It may also refer to a procedure where the UE has completed the cell or network selection/reselection process and has chosen a cell or network from which it plans to receive all available services. Additionally, it may refer to the process of selecting a cell of the PLMN or network and completing any necessary procedures (e.g., Location Registration) to access services from the network.

The terms “area”, “location”, “geographical area” used in the embodiment may refer to “cell/cell ID”, “Tracking Area Code (TAC)/Tracking Area Identity (TAI)”, “Public Land Mobile Network (PLMN)”, “Mobile Country Code (MCC)/Mobile Network Code (MNC)”, “latitude/longitude”, “Closed Access Group (CAG) cell”, or “any geographical location/coordinate”.

The term ACK (or acknowledgment) may refer to NAS/Access Stratum (AS) messages as described in TS 24.501/24.301 or 36.304/38.304. For an instance, when the UE sends an Attach/Tracking Area Update (TAU) request message, the MME onboard the satellite may provide an attach accept or TAU accept with the minimal context the MME/AMF is holding. Further, the MME/AMF onboard may deliver the NAS message to the ground MME/AMF. The ground MME/AMF may start executing the procedure, and when the procedure is executed, the MME/AMF will provide the attach accept/TAU accept/registration accept message, which will have all the contents required by the UE to create the UE context.

The term “serving satellite” may refer to the satellite providing the satellite access to the UE. In the case of a Non-Geostationary Satellite Orbit (NGSO), the serving satellite may continuously change due to nature of the constellation.

The term “store and forward retention period” may refer to the data storage validity period in the 5G network, with the satellite access supporting store and forward operation (e.g. after which undelivered data stored is being discarded).

The term “UE-satellite-UE communication” in the 5G network may refer to the satellite access, wherein the communication between UEs under the coverage of one or more serving satellites, using satellite access without going through the ground segment.

According to embodiments, a method for managing satellite communication using a store and forward (S&F) service with at least one network node onboard the satellite is provided. The method comprises determining, by a User Equipment (UE), that a network supports the store and forward service; and initiating, by the UE, at least one Non-Access Stratum (NAS) procedure with the network, wherein the UE re-attempts to provide a NAS signaling based on the received at least one store and forward information.

According to embodiments, a method for managing satellite communication is provided. The method comprises determining, by a core network node, that at least one NAS procedure initiated by a UE cannot be completed due to at least one store and forward (S&F) operation, wherein the core network node onboard the network; and providing, by the core network node, at least one S&F information to the UE, wherein the at least one S&F information comprises an indication of the UE in the S&F operation, a list of Satellite Identifications (IDs), and a S&F wait timer.

For example, at least one S&F operation is the store and forward satellite operation, in which a UE is provided with the level of service, by storing and forwarding the data or NAS signaling for a period of time and/or geographical location in which the satellite serves the UE through a service link.

For example, the indication of UE in the S&F operation indicates that at least one NAS procedure cannot be completed in the UE due to the S&F Satellite operation and that the UE can re-attempt at least one NAS procedure in the Public Land Mobile Network (PLMN) during next satellite pass.

For example, the indication of the UE in the S&F operation indicates that the information in the NAS message is stored in the Mobility Management Entity (MME) and the network will be available for the UE to re-attempt after interacting with the ground network.

For example, the S&F wait timer indicates the UE about the time to wait before re-attempting a new NAS procedure, the new NAS procedure comprises at least one attach procedure, control plane service request, Tracking Area Update (TAU), service request on the current or another satellite of the same PLMN or equivalent PLMN.

For example, the indication of the UE in the S&F operation indicates the list of Satellite IDs over which the UE re-attempt the NAS procedure or trigger the new NAS procedure.

For example, the UE is configured to attempt on the list of Satellite IDs, on identifying the wait time expiry.

For example, the UE determines the Satellite IDs based on the System Information Block (SIB) broadcasted by an evolved Node B (eNB).

For example, the NAS signaling comprises at least one attach procedure, a registration procedure, a service request procedure, and a detach procedure.

For example, the core network node onboard the satellite comprises at least one of Next Generation Node B (gNB), an Access and Mobility Management Function (AMF), a Mobility Management Entity (MME), a Serving Gateway (S-GW), a User Plane Function (UPF), a Policy Control Function (PCF), a Network Exposure Function (NEF), and a Proxy Data Network (Proxy-DN).

For example, the UE detaches from an Access Stratum (AS) and a Non-Access Stratum (NAS), on entering a power-saving mode.

According to embodiments, a system for managing satellite using a store and forward (S&F) service with at least one network node onboard the satellite is provided. The system comprises a processor (402); a memory (404). The processor (402) is configured to determine that a network supports the store and forward service; initiate at least one Non-Access Stratum (NAS) procedure by the UE with the network. The UE re-attempts to provide a NAS signaling based on the received at least one store and forward information.

According to embodiments, a system for managing satellite using a store and forward (S&F) service with at least one network node onboard the satellite is provided. The system comprises determine that at least one NAS procedure initiated by a UE cannot be completed due to at least one store and forward (S&F) operation, wherein the core network node onboard the network; and provide at least one S&F information to the UE, wherein the at least one S&F information comprises an indication of the UE in the S&F operation, a list of Satellite Identifications (IDs), and a S&F wait timer.

For example, at least one S&F operation is the store and forward satellite operation, in which a UE is provided with the level of service, by storing and forwarding the data or NAS signaling for a period of time and/or geographical location in which the satellite serves the UE through a service link.

For example, the indication of UE in the S&F operation indicates that at least one NAS procedure cannot be completed in the UE due to the S&F Satellite operation and that the UE can re-attempt at least one NAS procedure in the Public Land Mobile Network (PLMN) during next satellite pass.

For example, the indication of the UE in the S&F operation indicates that the information in the NAS message is stored in the Mobility Management Entity (MME) and the network will be available for the UE to re-attempt after interacting with the ground network.

For example, the S&F wait timer indicates the UE about the time to wait before re-attempting a new NAS procedure, the new NAS procedure comprises at least one attach procedure, control plane service request, Tracking Area Update (TAU), service request from the current or another satellite of the same PLMN or equivalent PLMN.

For example, the indication of the UE in the S&F operation indicates the list of Satellite IDs over which the UE re-attempt the NAS procedure or trigger the new NAS procedure.

For example, the UE is configured to attempt on the list of Satellite IDs, on identifying the wait time expiry.

For example, the UE determines the Satellite IDs based on the System Information Block (SIB) broadcasted by an evolved Node B (eNB).

For example, the NAS signaling comprises at least one attach procedure, a registration procedure, a service request procedure, and a detach procedure.

For example, the core network node onboard the satellite comprises at least one of Next Generation Node B (gNB), an Access and Mobility Management Function (AMF), a Mobility Management Entity (MME), a Serving Gateway (S-GW), a User Plane Function (UPF), a Policy Control Function (PCF), a Network Exposure Function (NEF), and a Proxy Data Network (Proxy-DN).

For example, the UE detaches from an Access Stratum (AS) and a Non-Access Stratum (NAS), on entering a power-saving mode.

According to embodiments, a method performed by a user equipment (UE) for satellite communication using a store and forward (S&F) service with at least one network node onboard the satellite is provided. The method comprises determining that the satellite supports the S&F service; initiating at least one non-access stratum (NAS) procedure with the satellite; based on the at least one NAS procedure, obtaining at least one S&F information including one or more satellite identifications (IDs); and attempting a NAS procedure based on the at least one S&F information.

For example, the attempting the attach procedure comprises in case that a reject message corresponding to an attach request of the UE is received, attempting at least one the satellite corresponding to at least one of the one or more satellite IDs based on a waiting timer.

For example, the at least one network node includes an evolved node-B (eNB), mobility management entity (MME), serving gateway (SGW), and home subscriber server (HSS).

For example, the attempting of the NAS procedure comprises re-attempting an attach procedure or a registration procedure with the satellite or triggering a new NAS procedure with another satellite corresponding to one of the one or more satellite IDs.

For example, the at least one S&F information includes information on a valid time for a service link provided by the satellite. The information on the valid time includes at least one of a start time, an end time, or a duration.

According to embodiments, a method performed by a satellite providing functions of at least one network node is provided. The method comprises determining that at least one non-access stratum (NAS) procedure initiated by a user equipment (UE) cannot be completed due to at least one store and forward (S&F) operation; providing, to the UE, at least one S&F information including one or more satellite identifications (IDs). The at least one S&F information is used for a NAS procedure with the UE.

For example, the at least one network node includes an evolved node-B (eNB), mobility management entity (MME), serving gateway (SGW), and Home Subscriber Server (HSS).

For example, the one or more satellite IDs are used for re-attempting an attach procedure with a wait timer in case that a reject message is provided to the UE.

For example, the one or more satellite IDs are used to re-attempt a NAS procedure or trigger a new NAS procedure by the UE.

For example, the one or more satellite IDs are obtained from system information block (SIB) broadcasted by an evolved Node B (eNB) on the satellite.

For example, the NAS signaling comprises at least one attach procedure, a registration procedure, a service request procedure, and a detach procedure.

For example, the at least one network node includes an evolved node-B (eNB), mobility management entity (MME), serving gateway (SGW), and home subscriber server (HSS).

For example, the at least one S&F information includes information on a valid time for a service link provided by the satellite. The information on the valid time includes at least one of a start time, an end time, or a duration.

According to embodiments, a user equipment (UE) for satellite communication using a store and forward (S&F) service with at least one network node onboard the satellite is provided. The UE comprises at least one processor comprising processing circuitry and memory storing instructions that, when executed by the at least one processor, cause the UE to perform operations including determining that the satellite supports the S&F service; initiating at least one non-access stratum (NAS) procedure with the satellite; based on the at least one NAS procedure, obtaining at least one S&F information including one or more satellite identifications (IDs); and attempting a NAS procedure based on the at least one S&F information. “Based on” as used herein covers based at least on.

According to embodiments, a satellite providing functions of at least one network node is provided. The satellite comprises at least one processor comprising processing circuitry and memory storing instructions that, when executed by the at least one processor, cause the satellite to perform operations including determining that at least one non-access stratum (NAS) procedure initiated by a user equipment (UE) cannot be completed due to at least one store and forward (S&F) operation; providing, to the UE, at least one S&F information including one or more satellite identifications (IDs). The at least one S&F information is used for a NAS procedure with the UE.

According to embodiments, a method performed by a user equipment (UE) supporting store and forward operation for satellite communication, may comprise transmitting a request message related to a non-access stratum (NAS) procedure to a satellite. The method may comprise receiving, from the satellite, a response message as a response of the request message from the satellite. The response message may include first information indicating a timer for waiting subsequent NAS procedure and second information indicating a list of one or more identifiers related to one or more satellites for attempting the subsequent NAS procedure. The method may comprise attempting the subsequent NAS procedure with a satellite among the one or more satellites according to the second information.

For example, the response message may comprise third information indicating a cause of rejection for the NAS procedure.

For example, the subsequent NAS procedure with the satellite may be attempted by the UE after the timer according to the first information expires.

For example, the one or more satellites may belong to the same public land mobile network (PLMN).

For example, each of the one or more satellites may comprise at least a part of a mobility management entity (MME).

According to embodiments, a method performed by a satellite supporting store and forward operation for satellite communication, may comprise receiving a request message related to a non-access stratum (NAS) procedure from a user equipment. The method may comprise transmitting a response message as a response of the request message from the satellite. The response message may include first information indicating a timer for waiting subsequent NAS procedure and second information indicating a list of one or more identifiers related to one or more satellites, including the satellite, for attempting the subsequent NAS procedure. The method may comprise performing, based on the response message, the subsequent NAS procedure with the UE.

For example, the response message may comprise a third information indicating a cause of rejection for the NAS procedure.

For example, the subsequent NAS procedure with the satellite may be attempted in the UE after the timer according to the first information expires.

For example, the one or more satellites may belong to the same public land mobile network (PLMN).

For example, the satellite may comprise at least a part of a mobility management entity (MME).

According to embodiments, a user equipment (UE) supporting store and forward operation for satellite communication, may comprise a transceiver, at least one processor comprising processing circuitry, and memory storing instructions. The instructions, when executed by the at least one processor, may cause the UE to transmit a request message related to a non-access stratum (NAS) procedure to a satellite. The instructions, when executed by the at least one processor, may cause the UE to receive a response message as a response of the request message from the satellite. The response message may include first information indicating a timer for waiting subsequent NAS procedure and second information indicating a list of one or more identifiers related to one or more satellites for attempting the subsequent NAS procedure. The instructions, when executed by the at least one processor, may cause the UE to attempt the subsequent NAS procedure with a satellite among the one or more satellites according to the second information.

For example, the response message may comprise third information indicating a cause of rejection for the NAS procedure.

For example, the subsequent NAS procedure with the satellite may be attempted by the UE after the timer according to the first information expires.

For example, the one or more satellites may belong to the same public land mobile network (PLMN).

For example, the satellite may comprise at least a part of a mobility management entity (MME).

According to embodiments, an apparatus of a satellite supporting store and forward operation for satellite communication, may comprise a transceiver, at least one processor comprising processing circuitry, and memory storing instructions. The instructions, when executed by the at least one processor, may cause the apparatus to receive a request message related to a non-access stratum (NAS) procedure from a user equipment. The instructions, when executed by the at least one processor, may cause the apparatus to transmit, to the UE, a response message as a response of the request message from the satellite. The response message may include first information indicating a timer for waiting subsequent NAS procedure and second information indicating a list of one or more identifiers related to one or more satellites, including the satellite, for attempting the subsequent NAS procedure. The instructions, when executed by the at least one processor, may cause the apparatus to perform, based on the response message, the subsequent NAS procedure with the UE.

For example, the response message may comprise a third information indicating a cause of rejection for the NAS procedure.

For example, the subsequent NAS procedure with the satellite may be attempted in the UE after the timer according to the first information expires.

For example, the one or more satellites may belong to the same public land mobile network (PLMN).

For example, the satellite may comprise at least a part of a mobility management entity (MME).

The embodiments disclosed herein can be implemented through at least one software program running on at least one hardware device and performing network management functions to control the network elements. The elements include blocks which can be at least one of a hardware device, or a combination of hardware device and software module.

The embodiments disclosed herein describe a circuit for performing analog calibration for a scalable multi-voltage memory interface driver. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high-speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the invention may be implemented on different hardware devices, e.g., using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

What is claimed is:

1. A method performed by a user equipment (UE) supporting store and forward operation for satellite communication, the method comprising:
transmitting a request message related to a non-access stratum (NAS) procedure to a satellite,
receiving, from the satellite, a response message as a response of the request message from the satellite, the response message including first information indicating a timer for waiting subsequent NAS procedure and second information indicating a list of one or more identifiers related to one or more satellites for attempting the subsequent NAS procedure, and
attempting the subsequent NAS procedure with a satellite among the one or more satellites according to the second information.

2. The method of claim 1, wherein the response message comprises third information indicating a cause of rejection for the NAS procedure.

3. The method of claim 1, wherein the subsequent NAS procedure with the satellite is attempted by the UE after the timer according to the first information expires.

4. The method of claim 1, wherein the one or more satellites belong to the same public land mobile network (PLMN).

5. The method of claim 1, wherein each of the one or more satellites comprises at least a part of a mobility management entity (MME).

6. A method performed by a satellite supporting store and forward operation for satellite communication, the method comprising:
receiving a request message related to a non-access stratum (NAS) procedure from a user equipment,
transmitting a response message as a response of the request message from the satellite, the response message including first information indicating a timer for waiting subsequent NAS procedure and second information indicating a list of one or more identifiers related to one or more satellites, including the satellite, for attempting the subsequent NAS procedure, and
performing, based on the response message, the subsequent NAS procedure with the UE.

7. The method of claim 6, wherein the response message comprises a third information indicating a cause of rejection for the NAS procedure.

8. The method of claim 6, wherein the subsequent NAS procedure with the satellite is attempted in the UE after the timer according to the first information expires.

9. The method of claim 6, wherein the one or more satellites belong to the same public land mobile network (PLMN).

10. The method of claim 6, wherein the satellite comprises at least a part of a mobility management entity (MME).

11. A user equipment (UE) supporting store and forward operation for satellite communication, comprising:
a transceiver;
at least one processor comprising processing circuitry; and
memory storing instructions that, when executed by the at least one processor, cause the UE to:
transmit a request message related to a non-access stratum (NAS) procedure to a satellite,
receive a response message as a response of the request message from the satellite, the response message including first information indicating a timer for waiting subsequent NAS procedure and second information indicating a list of one or more identifiers related to one or more satellites for attempting the subsequent NAS procedure, and
attempt the subsequent NAS procedure with a satellite among the one or more satellites according to the second information.

12. The UE of claim 11, wherein the response message comprises third information indicating a cause of rejection for the NAS procedure.

13. The UE of claim 11, wherein the subsequent NAS procedure with the satellite is attempted by the UE after the timer according to the first information expires.

14. The UE of claim 11, wherein the one or more satellites belong to the same public land mobile network (PLMN).

15. The UE of claim 11, wherein the satellite comprises at least a part of a mobility management entity (MME).

16. An apparatus of a satellite supporting store and forward operation for satellite communication, comprising:
a transceiver;
at least one processor comprising processing circuitry; and
memory storing instructions that, when executed by the at least one processor, cause the apparatus to:
receive a request message related to a non-access stratum (NAS) procedure from a user equipment,
transmit, to the UE, a response message as a response of the request message from the satellite, the response message including first information indicating a timer for waiting subsequent NAS procedure and second information indicating a list of one or more identifiers related to one or more satellites, including the satellite, for attempting the subsequent NAS procedure, and
perform, based on the response message, the subsequent NAS procedure with the UE.

17. The apparatus of claim 16, wherein the response message comprises a third information indicating a cause of rejection for the NAS procedure.

18. The apparatus of claim 16, wherein the subsequent NAS procedure with the satellite is attempted in the UE after the timer according to the first information expires.

19. The apparatus of claim 16, wherein the one or more satellites belong to the same public land mobile network (PLMN).

20. The apparatus of claim 16, wherein the satellite comprises at least a part of a mobility management entity (MME).
